(19) United States
(12) Patent Application Publication
(10) Pub. No.: US 2010/0253701 A1
(43) Pub. Date: Oct. 7, 2010

(54) Map display apparatus

(75) Inventors: Takeshi Yamada, Kariya-city (JP); Yukihiro Kajita, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/656,211

(22) Filed: Jan. 21, 2010

(30) Foreign Application Priority Data
Apr. 1, 2009 (JP) 2009-89517

(51) Int. Cl. G09G 5/00

(52) U.S. Cl. 345/660

(57) ABSTRACT

A map display apparatus receives an input of an expansion center point specified by an operation unit, and then retrieves, from an external memory, a base map having the largest scale also specified by the operation unit together with less larger scaled maps. The apparatus masks each of the retrieved base maps by generating mask parts for each of the base maps. The base maps and the generated mask parts are layered in an alternate manner to create a partially expanded map that provides an intuitive recognition of positional relationship with a reduced map creation process load.

### CROSS REFERENCE TO RELATED APPLICATION

The present application is based on and claims the benefit of priority of Japanese Patent Application No. 2009-89517, filed on Apr. 1, 2009, the disclosure of which is incorporated herein by reference.

### FIELD OF THE INVENTION

The present invention generally relates to a map display apparatus displaying a partially expanded map that has an increasingly larger map scale towards an expanded view in a map.

### BACKGROUND INFORMATION

A conventional technique for displaying a partially expanded map is, for example, disclosed in a patent document 1, JP-A-2000-221874. In the disclosure of the technique, an original map of a constant scale is displayed on the screen, and an expanded view is added when a portion of the original map is specified by the operation of a mouse or other pointing device. The expanded view of the map has a larger scale relative to the original map, and the expanded view of the map is surrounded by the original map on the screen. That is, except for the expanded view, display of the original map is kept unchanged on the screen.

In addition, the map display apparatus in the patent document 1 switches the display of the original map with the display of the expanded view when a switch instruction is input from the mouse or the like. The entire screen is switched from the original map to its expanded view.

On the other hand, according to a patent document 2, JP-A-H09-244528, a map display apparatus used in a vehicle displays a closer area close to the current vehicle position in a larger scale, and a farther area in a smaller scale.

However, the technique in the above patent document 1 makes it difficult to understand the positional relationship between the expanded view of the map and the original map due to the change of the map scale in respective maps. That is, for example, a road section in the original map may not be easily associated with a road section in the expanded view.

Further, in the above patent document 1, the display of the map is entirely switched from the original map to the expanded view. This situation may also make it difficult to associate a road in the original map before switching with a road in the expanded view after switching.

The apparatus in the patent document 2 may ease the difficulty in the technique in the patent document 1, due to the increasingly larger scale of the map towards the expanded view in the map.

However, process load for making a map image is increased in the technique used in the apparatus of the patent document 2, due to a partial expansion conversion and a partial reduction conversion in the course of making the partially expanded map from the original map having a constant scale throughout the mapped area.

### SUMMARY OF THE INVENTION

In view of the above and other problems, the present invention provides a map display apparatus that achieves a reduction of a process load of map image processing as well as an easily recognizable positional relationship between mapped objects.

In an aspect of the present invention, the map display apparatus includes: a base map storage unit for storing a plurality of base maps with respectively different scales; a mask unit for generating a plurality of mask parts respectively for at least three base maps that are retrieved from the base map storage unit; and a display control unit for alternately layering the base maps and masks according to a scale order to display a partially expanded map on a screen. The plurality of mask parts includes a first, a second and a third mask part. The first mask part masks a largest scale base map that is to be displayed as an expanded view, the second mask part masks an intermediate scale base map that is to be displayed as an intermediate view that circularly surrounds the larger scale view, and the third mask part masks a smallest scale base map that is to be displayed as a background view.

The above expansion scheme of the map enables the reduction of the map image processing, as well as the easy recognition of the positional relationship, because the map scale is gradually increased towards the expanded view in the map. Further, by alternating the maps and the masks in an order of increasing scales as different layers, the process load is reduced in comparison to the process that partially converts the map scale from small to large and large to small. That is, in other words, the easily recognizable positional relationship and the process load reduction can both be achieved without compromise.

Further, the partially expanded map can have an increased amount of information when the expanded view is made by layering the different scale maps in comparison to the expanded view simply made by the partial conversion of single original map having a constant map scale. This advantage is more apparent based on the fact that the same map area (i.e., a certain block of a downtown, for example) has the larger amount of data when its scale is larger.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a map display apparatus in an embodiment of the present invention;

FIG. 2 is an illustration of layers of base maps and masks in an order of respective scales in the embodiment;

FIG. 3 is an illustration of a partially expanded map in the embodiment; and

FIG. 4 is an illustration of a conventional map displayed on a screen.

### DETAILED DESCRIPTION

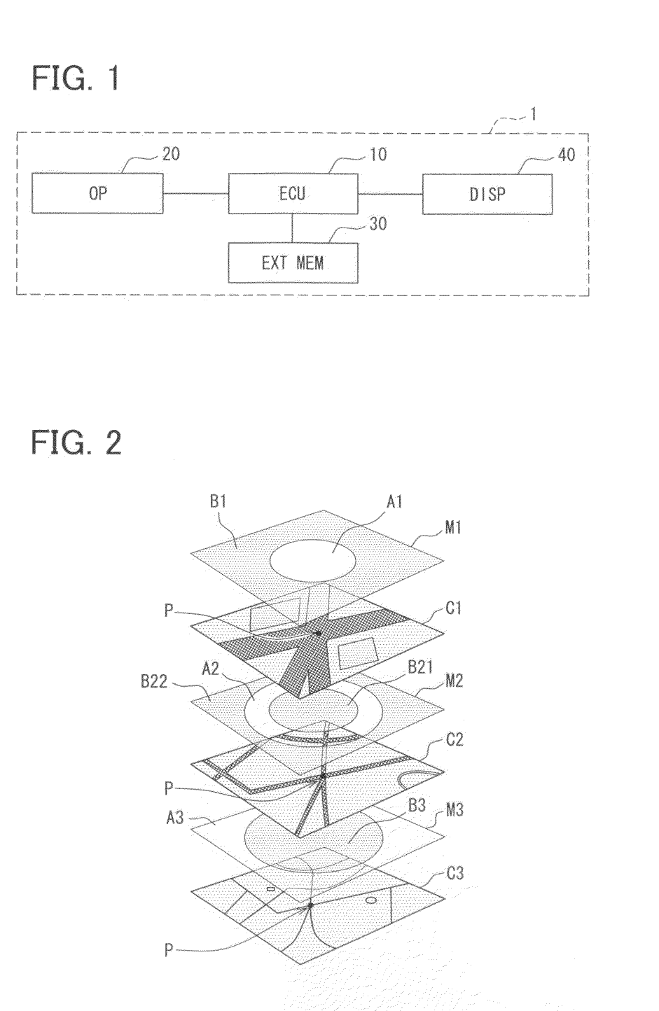

An embodiment of the present invention is explained with reference to FIGS. 1 to 4. FIG. 1 is a block diagram of a map display apparatus 1 in an embodiment of the present invention, and FIG. 2 is an illustration of layers of base maps and masks in an order of respective scales, that is, a partially expanded map which has an expanded view at its center and has smaller scale views around the expanded view.

The map display apparatus 1 is embodied as a part of a navigation system for navigating a vehicle from an inputted departure place to a destination, and includes an ECU 10, an operation unit 20, an external memory 30, and a display screen 40 as shown in FIG. 1.

The operation unit 20 has a push button and the like, and is disposed around the around the display screen 40, and is connected to the ECU 10. The user specifies a center point of the expanded view in the map by using a mouse cursor on the display screen 40. That is, an arbitrary spot in the map can be specified as an expansion center point. After specifying the center point, the center point is inputted to the ECU 10, and the ECU 10 recognizes a circular area having a certain radius around the inputted center point as the expanded view of the map.

In addition, the user specifies the largest scale of the map for generating the partially expanded map that has a larger map scale as a view is closer to expanded view at its center by using the operation unit 20 from a predetermined selection of scales. That is, the user can arbitrarily select a scale of the expanded view. After the selection of the scale, the selected scale is inputted to the ECU 10.

In addition, switching between a normal map and the partially expanded map is performed by operating the operation unit 20. That is, the display of a map on the display screen 40 can be switched by the operation unit 20 at any time. The switching instruction from the operation unit 20 is inputted to the ECU 10. The operation unit 20 is an equivalent of a location unit, a scale unit, and a switching unit in claim language.

Though a push button is adopted as the operation unit 20 in the present embodiment mode, any operation device can alternatively be used as the operation unit 20, as long as the device is capable of specifying the center point of the expansion, the largest scale of expansion, and capable of providing map switching instruction.

The external memory 30 is constituted by a flash memory or a hard disk drive of well-known type, and stores programs to be carried out by the ECU 10 as well as other data such as a normal map (i.e., a map with no partially expanded view) of different scales. The map of different scales has different objects mapped therein. That is, more practically, the larger scale map has an outline of homes, small facilities and small roads, while the smaller scale map has an outline of factories, large facilities and wide expressways without smaller details. In addition, the external memory 30 is connected to the ECU 10, and map images in the external memory 30 are retrieved by the ECU 10. Further, the external memory 30 is an equivalent of a storage unit, and the normal map is an equivalent of a base map in claim language.

In the present embodiment, map images are stored by a unit of layers and meshes in the external memory 30 for each of the different scales and for each of divided areas. That is, a map of 1:1000000 scale, a map of 1:500000 scale, a map of 1:25000.0 scale, a map of 1:100000 scale, a pap of 1:50000 scale, a map of 1:10000 scale, a map of 1:5000 scale, a map of 1:1000 scale, and the like are available as stored information. The normal map of other scaling may also be stored. In the above notation, the “scale” means a fraction having a numerator of 1 divided by a denominator of 1000 or the like. Further, the smaller the denominator value is, the “larger” the scale is, and the greater the denominator value is, the “smaller” the scale is. When the map scale is “large,” the mapped object such as a home, a road and the like looks large.

The display screen 40 is constituted by a liquid crystal display (LCD), for example, and is disposed at a position where an occupant of the vehicle is viewable. Further, the display screen 40 is connected to the ECU 10, and the display contents of the display screen 40 such as the expanded map image or the normal map image are controlled by the ECU 10.

The ECU 10 is a computer of well-known kinds, which has a CPU, a built-in memory and the like (not illustrated), and executes programs stored either in the built-in memory and/or the external memory 30 for carrying out various processes.

The partially expanded map is created and displayed in the following manner under control of the ECU 10. The ECU 10 first retrieves, from the external memory 30, the normal maps of at least three different scales (i.e., a map of the specified largest scale and other maps of less larger scales) for an area that includes the specified center point of expansion. Then, the ECU 10 generates at least three mask parts in the manner described in the following.

Suppose there are three normal maps C1 to C3 retrieved by the ECU 10 from the memory 30 by the operation of the operation unit 20, as shown in FIG. 2, respectively including a specified expansion center point P, in the scales also specified by the operation unit 20. In this case, the map C1 has the largest scale among the retrieved maps, and the map C3 has the smallest scale, and the map C2 has an intermediate scale between the largest and the smallest.

Then, the ECU 10 generates mask parts for masking the retrieved maps C1 to C3. That is, a mask M1 is generated for masking the map C1 to extract a circular display area A1 around the center point P. In other words, the area outside the display area A1 is covered by a mask area B1 of the mask M1.

Then, a mask M2 is generated for masking the map C2 to extract a ring-shape display area A2 that is adjacent to the area A1. That is, the mask M2 has two mask areas: a mask area B21 for masking an inside of the area A2 and a mask area B22 for masking an outside of the area A2. The mask areas B21 and B22 may be denoted collectively as a mask area B2.

Then, a mask M3 is generated for masking the map C3 to extract a display area A3. That is, the mask M3 has a mask area B3 that covers both of the two display areas A2 and A1 that are not covered by the mask M2 and M1. In other words, the display area A3 is an outside of the mask area B3.

The number of retrieved maps may be more than 3 in the above masking method. If more than three maps are retrieved, the above masking method may be expanded to generate more masks for covering respective maps. The shape of the masks may be different from a circular shape. That is, in other words, the display area A1 may have a rectangular shape, or an oval shape, or a still other shape. Likewise, the display area A2 may have a different shape that is different from the ring shape. That is, the display area A2 may have any shape that surrounds the display area A1 with no interposing area between the area A1 and A2. The ECU 10 is an equivalent of a mask unit in claim language.

Then, the ECU 10 layers the maps C1 to C3 together with the generated mask M1 to M3 alternately in an order of scales for making the partially expanded map.

More practically, the ECU 10 layers, from top to bottom, the mask M1-the map C1-the mask M2-the map C2-the mask M3-the map C3, in this written order. As a result, the partially expanded map has an expanded view from the largest scale map C1 in the display area A1 that centers around the point P, with the intermediate scale map C2 for the surrounding display area A2, and the smallest scale map C3 for the background area, that is, the outer most display area A3. That is, the partially expanded map has a larger map scale as the display area approaches the center point P. In this case, the ECU 10 is an equivalent of a display control unit in claim language.

In the partially expanded map made in the above-described manner, an outline of, for example, a straight road may not look continuous if the map scale of the expanded view (i.e., scale of map C1) and the map scale of the surrounding area (i.e., scale of map C2) are greatly different. That is, the straight road may be displayed as a step-wise road of various widths on the screen at the boundary of the two areas. The same phenomenon may be observed for the boundary between the surrounding area (i.e., map C2) and the outer most area (i.e., map C3) if the difference of two map scales is great. Further, not only the outline of the road but the outline of other mapped objects such as a home, a factory and the like may have the same discontinuity.

Therefore, in the present embodiment, the ECU 10 performs an image smoothing process for those boundaries after making the partially expanded map. That is, the discontinuous outline of the road is smoothly connected through those boundaries, from the expanded view to the outer most display area by the image smoothing process. The image smoothing process of the map image is performed by using a well-known technique.

Then, the ECU 10 displays on the display screen 40 the partially expanded map. The ECU 10 is an equivalent of an image process unit in claim language.

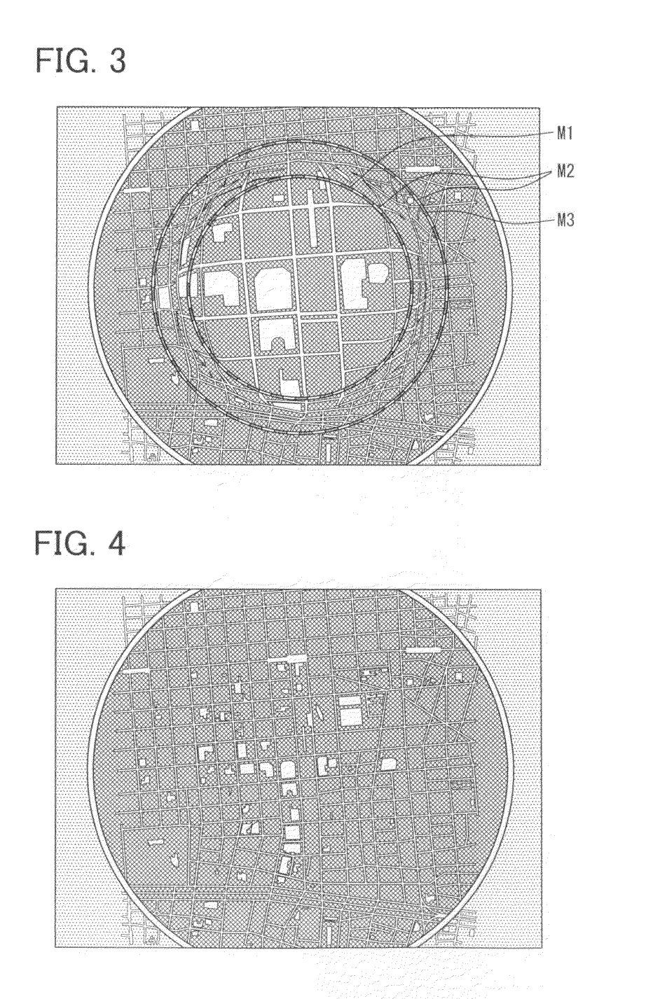

An example of the partially expanded map displayed by the map display apparatus 1 is shown in FIG. 3. In an illustration of FIG. 3, the circle indicated as M1 is the boundary between the display area A1 of the mask M1 and the mask area B1 (i.e., the display area A2), and the circle indicated as M3 is the boundary between the display area A2 of the mask M2 and the mask area B22 (i.e., the display area A3). The map with no expanded view is shown in FIG. 4 for comparison. The map display apparatus 1 of the present embodiment enables a display of the partially expanded map that has the larger map scale as the view approaches the center point of the expansion.

The operation and advantages of the present map display apparatus 1 are summarized as follows. That is, upon having the center point P of the expansion by the operation of the operation unit 20, the maps C1 to C3 of the specified largest scale and the smaller scales are retrieved from the external memory 30. Then, the masks M1 to M3 for the display of the areas A1 to A3 of the maps C1 to C3 are respectively generated. Then, the map display apparatus 1 layers the masks M1 to M3 with the maps C1 to C3 alternately one over the other in an order of scales from a large scale to smaller scales, for making the partially expanded map. Therefore, the partially expanded map provides an intuitively recognizable display of positional relationships between mapped objects existing in both of the expanded view and the normal view. Further, the process load for making the partially expanded map is greatly reduced by the above-described alternate layering of the maps and masks. Furthermore, the partial extraction of the mapped objects from each of the different scale maps leads to an increase of the mapped contents (i.e., mapped information) in the partially expanded map.

Further, the smoothing process for the boundaries of the two adjacent areas (A1 and A2, A2 and A3) by the map display apparatus 1 leads to an easily viewable map that smoothly changes the map scale towards the center point of the expanded view.

Although the present disclosure has been fully described in connection with preferred embodiment thereof with reference to the accompanying drawings, it is to be noted that various changes and modifications will become apparent to those skilled in the art.

For example, the smoothing process for the area boundaries may be omitted. Instead of performing the boundary smoothing process, providing more finely defined intermediate display areas between the largest scale and the smallest scale may creating the same smoothing effects. That is, by retrieving more maps from the external memory 30 and generating more masks, the same smoothing effects can be achieved for the outline of the homes and other mapped objects.

Further, the number of the center point P for the expansion may be two or more. For example, the departure place and the destination of the travel may respectively be specified as the center point P, and the route map may be displayed as a map with two expanded views included therein. If the third center point P is specified, the expanded view may be provided for the third center point P.

Further, the center point P for the expansion may be a moving point. That is, the current vehicle position or the like may be used as the center point P. The process load reduction for making the map may further be apparent when the moving point is used as the center point of the expanded view. In this case, the display screen 40 can display the moving expanded view as the vehicle travels along the navigation route.

Further, the size and shape of the expanded view may be selected from predetermined selection options by the user by the operation of the operation unit 20.

The map display apparatus 1 may be implemented and provided as a part of an apparatus of any kind, besides the navigation apparatus. For example, a mobile equipment such as a cellular phone or the like may include the map display apparatus 1 of the present embodiment. Further, the direction board in a station, a department store, or the like may include the map display apparatus 1 of the present embodiment. The map display apparatus 1 of the present embodiment may also be applicable to a device that handles a map of any kind.

Such changes, modifications, and summarized operation schemes are to be understood as being within the scope of the present disclosure as defined by appended claims.

What is claimed is:

1. A map display apparatus comprising:
a base map storage unit for storing a plurality of base maps with respectively different scales;
a mask unit for generating a plurality of mask parts respectively for at least three base maps that are retrieved from the base map storage unit, wherein a first mask part masks a largest scale base map that is to be displayed as an expanded view, a second mask part masks an intermediate scale base map that is to be displayed as an intermediate view that circularly surrounds the larger scale view, and a third mask part masks a smallest scale base map that is to be displayed as a background view; and
a display control unit for alternately layering the base maps and masks according to a scale order to display a partially expanded map on a screen.

2. The map display apparatus of claim 1 further comprising:
an image process unit for smoothing boundaries between two base maps of different scale.

3. The map display apparatus of claim 1 further comprising:
a location unit for specifying a location of the expanded view, wherein
the mask unit generates the plurality of mask parts based on the location of the expanded view.

4. The map display apparatus of claim 1 further comprising:
a scale unit for specifying a largest scale of the base map to be used as the expanded view, wherein
the mask unit retrieves the plurality of base maps having scales equal to or smaller than the largest scale specified by the scale unit.

5. The map display apparatus of claim 1 further comprising:
a switching unit for switching a screen display between the partially expanded map and the base map, wherein
the display control unit displays the partially expanded map or the base map on the screen according to the switching by the switching unit.

6. The map display apparatus of claim 1 further comprising:
an operation unit for allowing an input of user selection, wherein
a shape of the mask part is selectively specified by the input from the operation unit.

7. The map display apparatus of claim 1 further comprising:
an operation unit for allowing an input of user selection, wherein
a size of the expanded view is selectively specified by the input from the operation unit.
